(19) United States
(12) Patent Application Publication
(10) Pub. No.: US 2026/0246076 A1
(43) Pub. Date: Aug. 20, 2026

(54) BATTERY PACK WITH IMPROVED VENTILATION

(71) Applicant: LG ENERGY SOLUTION, LTD., Seoul (KR)

(72) Inventors: Jinki MIN, Daejeon (KR); Soeun RHIM, Daejeon (KR)

(21) Appl. No.: 19/475,324

(22) PCT Filed: May 22, 2024
(86) PCT No.: PCT/KR2024/006940

§ 371 Date: Oct. 14, 2025

(30) Foreign Application Priority Data
May 24, 2023 (KR) 10-2023-0066904

(51) Int. Cl. H01M 50/383; H01M 10/658; H01M 50/204; H01M 50/249; H01M 50/262; H01M 50/30; H01M 50/367; H01M 50/375

(52) U.S. Cl. CPC H01M 50/383; H01M 10/658; H01M 50/204; H01M 50/249; H01M 50/262; H01M 50/367; H01M 50/375; H01M 50/394

(57) ABSTRACT

The present disclosure provides a structure of a battery pack including a plurality of battery modules in a widthwise direction thereof. Each of the plurality of battery modules include: an end plate comprising at least a portion of a rear surface of the battery module; and a rear cover connected to a rear end of the battery module, the rear cover having open front end and made of a heat-resistant material. The rear cover includes a pair of partition plates extending in rear direction from two widthwise ends of a rear end of the battery module; and a venting hole facing an upward direction.

### CROSS-REFERENCE WITH RELATED APPLICATIONS

This application is a National Phase entry pursuant to 35 U.S.C. 371 of International Application PCT/KR2024/006940 filed May 22, 2024, which claims the benefit of priority based on Korean Patent Application No. 10-2023-0066904 filed on May 24, 2023, the disclosures of which are incorporated herein by reference in their entirety.

### TECHNICAL FIELD

The present disclosure relates to a battery pack with improved ventilation, and more particularly, to a battery pack capable of preventing thermal runaway and controlling venting direction.

### BACKGROUND

Secondary batteries, which provides ease of application depending on the product group and have electrical characteristics such as high energy density, are widely applied not only to portable devices, but also to electric vehicles or hybrid vehicles driven by an electrical driving source, and power storage devices. These secondary batteries are attracting attention as a new energy source for improving eco-friendliness and energy efficiency, not only because they have the primary advantage of being able to dramatically reduce the use of fossil fuels, but also because they do not generate any by-products due to energy use.

While small mobile devices use one or two or three battery cells per device, medium to large devices such as vehicles require high output and large capacity. Therefore, a medium to large-sized battery module in which multiple battery cells are electrically connected is used.

Since it is desirable for medium to large-sized battery modules to be manufactured in as small and light as possible, rectangular batteries and pouch-type batteries that may be stacked with high integration and have a small weight-to-capacity battery are mainly used as battery cells for medium to large-sized battery modules.

FIG. 1 illustrates the structure of a general battery module and the venting direction at the rear end thereof, and FIG. 2 illustrates a cross-section of the battery module of FIG. 1. Referring to FIGS. 1 and 2, a general battery module 1 is manufactured by accommodating a plurality of stacked battery cells 14 in a housing. The housing generally includes of a U frame 11, a top plate 13 and a pair of end plates 12. The end plate 12 has a dual structure of a metal portion 122 bonded to the U frame 11 and an injection portion 121 that insulates the metal portion 122 from the battery cell 14 within the U frame 11.

The battery cell 14 has a risk of ignition due to shock, short circuit, etc. High-temperature gas and dust generated as a result may be discharged from the battery module 1. Here, the gas and dust may be discharged in the rear direction through the bonding area of the metal portion 122 and the U frame 11 and through the portion of the injection portion 121 exposed to the outside.

FIG. 3 illustrates a structure of a battery pack containing the battery module of FIG. 1, and FIG. 4 illustrates thermal propagation occurring in the rear space of the battery pack of FIG. 3. Referring to FIGS. 3 and 4, a plurality of battery modules 1 may be integrated and accommodated in a pack frame 4 to constitute a battery pack P. Gas and dust discharged from the battery module 1 may be discharged to the outside of the pack frame 4 through a rear space 41 between the pack frame 4 and each battery module 1 and through a venting device (not shown) that connects the inside and outside.

Here, the gas discharged from the battery module 1 has a very high temperature, and there is a risk that other battery modules may additionally ignite due to such high-temperature gas. In addition, in order for gas to be discharged through the venting device, it is necessary that the gas discharged from the battery module 1 is guided upward. However, due to the rear space 41, the gas discharged from the battery module 1 in the rear direction may be disperse in the lateral direction such that heat is transmitted to other battery modules, which may cause serial ignition between the modules.

Moreover, here, dust discharged upward through the rear space may close the venting path including the venting device, making additional venting difficult.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

In order to solve above-described problems of the prior art, it is an object of the present disclosure to provide a structure of a battery module wherein thermal propagation between a plurality of battery modules embedded in a battery pack is prevented. More specifically, the present disclosure provides a structure of a battery pack capable of preventing thermal propagation from occurring as high-temperature gas and/or flame discharged through the rear end of one battery pack reaches other adjacent battery modules.

It is another object of the present disclosure to provide a structure of a battery module capable of guiding high-temperature gas and dust discharged from inside the battery module to be discharged in a specific direction. For example, it is an object of the present disclosure to provide a structure of a battery pack capable of guiding gas discharged through the front and rear ends of the battery module upward.

It is yet another object of the present disclosure to provide structures of a battery module and battery pack capable of cooling discharged gas.

It is yet another object of the present disclosure to provide structures of a battery module and battery pack capable of delaying venting and preventing flame generation due to spark leakage.

In addition, it is yet another object of the present disclosure to provide a structure of a battery pack capable of preventing ignition and obstructing of the venting path due to dust.

The technical problems to be solved by the present disclosure are not limited to the objects described above, and other objects and advantages of the present disclosure that are not described may be understood through the following description and will be more clearly understood by the examples of the present disclosure. Additionally, it is apparent that the objects and advantages of the present disclosure may be embodied by the means and combinations thereof indicated in the claims.

In order to solve the above-described problems, the present disclosure provides a structure of a battery pack including a plurality of battery modules in a widthwise direction thereof, each of the plurality of battery modules including: an end plate comprising at least a portion of a rear surface of the battery module; and a rear cover at a rear end of the end plate, the rear cover having an open front end and made of a heat-resistant material, wherein the rear cover includes: a pair of partition plates extending in a rear direction from two widthwise ends of a rear end of the battery module; and a venting hole facing upward direction.

The battery pack may include a pack frame and a plurality of battery modules adjacent to each other and accommodated in the pack frame. Two or more battery modules may arranged with the rear ends thereof face the same direction and are adjacent to each other in the widthwise direction.

The battery module may include a battery cell laminate and a housing to accommodate the same. The housing may include a U frame with open upper, front and rear ends, a top plate covering the open upper end of the U frame, and a pair of end plates covering the open front and rear ends of the U frame.

The rear cover may be made of a heat-resistant material. The rear cover according to an embodiment of the present disclosure may include a mica material.

The rear cover may have an open front end connected to the rear end of the battery module. In addition, it is preferable that the rear cover has an open lower end similar to the front end.

The rear cover may further include an upper plate connecting upper end portions of the pair of partition plates to each other and covers an upper end of the rear cover, Here, the venting hole may be provided in the upper plate.

Additionally, the rear cover may include a rear plate connecting the rear ends of the pair of partition plates to each other and covering a rear end of the rear cover.

The rear cover according to an embodiment of the present disclosure may be substantially box shaped with open front and lower ends. Accordingly, gas discharged from the battery module in the rear direction may flow into the rear cover from the open front end thereof and be discharged to the upper end thereof through the venting hole. In addition, accordingly, dust discharged from the battery module in the rear direction may flow the rear cover from the open front end thereof and fall to the lower end thereof through the open lower end thereof. As the discharge path of the gas is bent from the rear direction to the upward direction, the gas may lose some of its energy and be cooled and discharged.

The partition plate may isolate the rear end space of the battery module from two widthwise ends thereof. The partition plate may isolate the rear end space of the battery module from the two widthwise ends thereof at least in some sections in the heightwise direction. Here, the partition plate may cover some of the two widthwise ends of the battery module.

The rear cover may be connected to the rear end of the battery module. For example, the rear cover may be connected to the rear end plate. Alternatively, the rear cover may be connected to the U frame or the top plate.

The rear cover may be fastened to a first fastening hole provided in the battery module. The first fastening hole may be provided to face upward at the rear end of the battery module. For example, the first fastening hole may be provided at the end plate, the top plate or the U frame.

Here, a second fastening hole may be provided at the rear cover to face upward direction. Preferably, the second fastening hole may be provided in the upper plate together with the venting hole.

The rear cover according to an embodiment of the present disclosure may have an upper plate covering a portion of an upper surface of the battery module, and may be fastened to the battery module by a fastening member that penetrates both the first fastening hole and the second fastening hole. The fastening member may be a general fastening member such as a bolt or push rivet, but not limited thereto. For example, the fastening member may be a click fit protrusion provided as part of the rear cover or the battery module.

The rear cover may include a melting frame. The melting frame may have a predetermined melting point lower than the melting point of the rear cover. The melting frame according to an embodiment of the present disclosure may include a polycarbonate (PC) material.

The melting frame may be in contact with the inner surface or surface of the rear cover. Preferably, the melting frame may be coupled to the rear cover so as to be in contact with the inside of the rear cover.

The melting frame may include a venting delaying portion covering the venting hole.

The melting frame according to an embodiment of the present disclosure may be substantially box shaped with open front and rear ends, and the venting delaying portion is provided at the upper plate of the melting frame provided at the lower end of the upper plate of the rear cover such that the venting hole is covered from the bottom.

The venting delaying portion may be thinner than other portions of the melting frame. Accordingly, when the venting delaying portion is heated above the melting point, the venting delaying portion may be completely melted faster than other portions of the melting frame.

According to an embodiment of the present disclosure, an upper plate and a lower plate of the melting frame may be thinner than two side plates thereof. When the upper and lower plates of the melting frame are heated above the melting point, the upper and lower plates may be completely melted faster than other portions of the melting frame. Accordingly, when venting occurs in the battery module, gas discharged from the battery module may be discharged to the upper end of the rear cover, and dust discharged from the battery module may fall to the lower end of the rear cover. Here, such venting may occur with a delay lasting the melting time of the upper and lower plates of the melting frame.

The venting hole may be covered with a mesh, or may have a mesh shape. Alternatively, the venting hole may have a slit shape. The gas discharged from the battery module may be discharged through a small opening in the mesh or slit as described above such that the discharge may be delayed and may be cooled and discharged due to a throttling effect.

The present disclosure also provides a structure of a vehicle including the battery pack. The battery pack may be built into an electric vehicle or hybrid vehicle as a power source. According to an embodiment of the present disclosure, gas vented upward from the battery module may be discharged from the inside of the pack frame to the outside through a venting device provided in the pack frame.

By the technical solution described above, the present disclosure may provide a structure of a battery pack capable of preventing thermal propagation between modules due to gas discharged from the rear end of the battery module.

Additionally, the present disclosure may provide structures of battery module and battery pack capable of delaying venting and guiding venting in upward direction.

The present disclosure may advantageously provide structures of battery module and battery pack capable of preventing leakage of sparks to reduce the possibility of ignition.

The present disclosure may also provide structures of battery module and battery pack capable of cooling and discharging high-temperature gas.

The present disclosure may also provide a structure of a battery pack wherein the possibility of ventilation path obstruction and ignition due to dust is significantly reduced.

In addition, the present disclosure may have various other effects, and the descriptions thereof will be given in each embodiment, or the description of the effects that may be easily inferred by a person skilled in the art will be omitted.

### BRIEF DESCRIPTION OF THE DRAWINGS

FIG. 1 illustrates the structure of a general battery module and the venting direction at the rear end thereof.

FIG. 2 illustrates a cross-section of the battery module of FIG. 1.

FIG. 3 illustrates a structure of a battery pack containing the battery module of FIG. 1.

FIG. 4 illustrates thermal propagation occurring in the rear space of the battery pack of FIG. 3.

FIGS. 5 to 7 illustrate a battery module and a rear cover coupled to each other according to an embodiment of the present disclosure.

FIG. 8 illustrates a cross-section of a rear cover and a melting frame according to an embodiment of the present disclosure.

FIGS. 9 and 10 illustrate a battery module and a rear cover fastened to each other according to an embodiment of the present disclosure.

FIG. 11 illustrates a structure before melting of the melting frame according to an embodiment of the present disclosure.

FIG. 12 illustrates a cross-section of the structure of FIG. 11.

FIG. 13 illustrates a structure after melting of the melting frame according to an embodiment of the present disclosure.

FIG. 14 illustrates a cross-section of the structure of FIG. 13.

FIG. 15 illustrates the venting action and thermal propagation prevention action of a battery module according to an embodiment of the present disclosure.

FIGS. 16 and 17 illustrate the venting action and thermal propagation prevention action of a battery pack, respectively, according to an embodiment of the present disclosure.

FIG. 17 illustrates the thermal propagation prevention action of a battery pack according to an embodiment of the present disclosure.

FIGS. 18 and 19 illustrate coupling scheme of a battery module and a rear cover according to another embodiment of the present disclosure.

FIG. 20 illustrates a structure of a battery module according to another embodiment of the present disclosure.

FIG. 21 illustrates a cross-section of the battery module of FIG. 20.

FIG. 22 illustrates the venting action and thermal propagation prevention action of a battery module according to another embodiment of the present disclosure.

FIGS. 23 and 24 illustrate the venting action and thermal propagation prevention action of a battery pack, respectively, according to another embodiment of the present disclosure.

FIG. 25 illustrates the structure of a vehicle containing a battery pack according to the present disclosure.

### DETAILED DESCRIPTION

The above-described objects, features and advantages will be described in detail hereinafter with reference to the accompanying drawings such that those skilled in the art will be able to implement the technical idea of the present disclosure. In describing the present disclosure, when it is determined that a detailed description of prior art related to the present disclosure unnecessarily obscures the gist of the present disclosure, the detailed description thereof will be omitted. Hereinafter, embodiments according to the present disclosure will be described in detail with reference to the accompanying drawings. In the drawings, identical reference numerals are used for indicating identical or similar components.

While “first”, “second”, etc. are used to describe various elements, these elements are of course not limited by these terms. These terms are only used to distinguish one element from another, and unless specifically stated otherwise, a first element may also be a second element.

Throughout the specification, unless stated otherwise, each element may be singular or plural.

Hereinafter, “arranging an element at upper portion (or lower portion) of an element” or “arranging an element at top (or bottom) of an element” refers to not only “arranging an element to be in contact with upper surface (or lower surface)” but also to “arranging an element above upper surface (or lower surface) with another element interposed therebetween.”

Additionally, when an element is described as being “connected to,” “coupled with,” or “in contact with” another element, it should be understood that the element may be “directly connected to,” “directly coupled with,” or “directly in contact with” another element, or the element may be “connected to,” “coupled with,” or “in contact with” another element with yet another element interposed therebetween or via yet another element.

The expressions in singular form used herein include expressions in plural form unless the context explicitly dictates otherwise. Terms such as “consists of” or “comprises” used herein should not be construed as necessarily including all of the elements or steps described in the specification, and should be construed as not including some of the elements or steps, or including additional elements or steps.

Throughout the specification, “A and/or B” refers to A, B or A and B unless specifically stated otherwise, and “C to D” refers to from equal to or higher than C to equal to or lower D unless specifically stated otherwise.

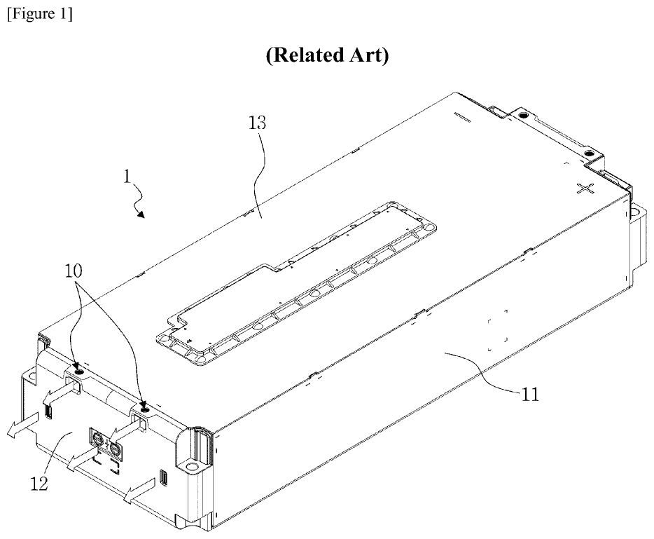

FIG. 1 illustrates the structure of a general battery module. Referring to FIG. 1, the battery module 1 may include a plurality of battery cells 14 and a housing accommodating the same. The housing includes a U frame 11 with open upper, front and rear ends, a top plate 13 covering the open upper end of the U frame 11, and a pair of end plates 12 covering the open front and rear ends of the U frame 11, respectively.

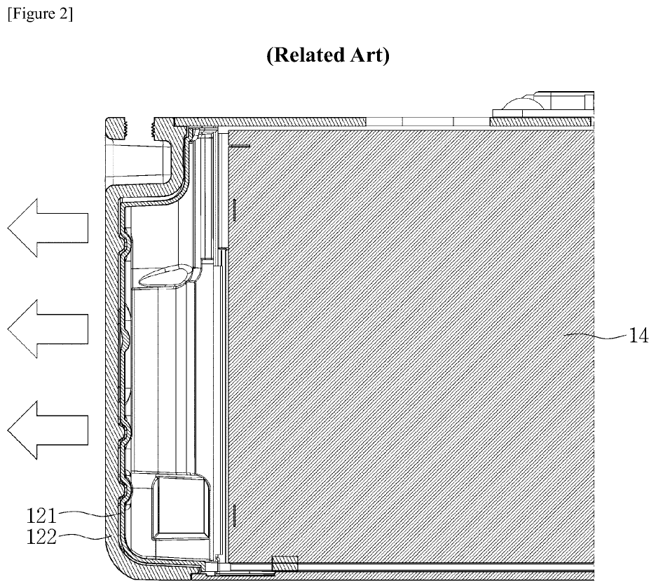

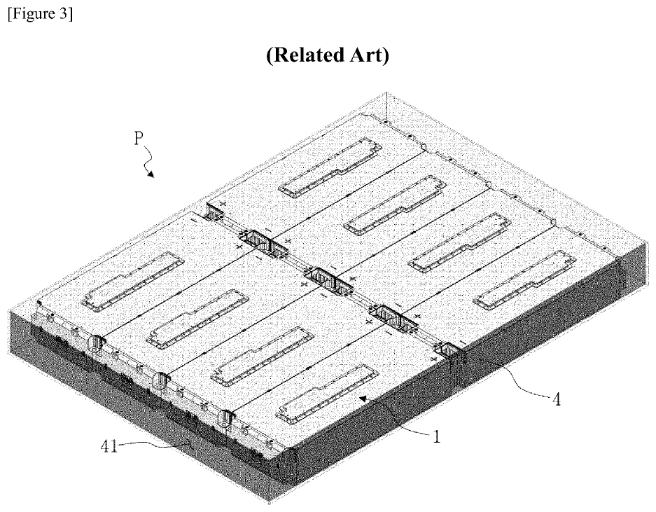

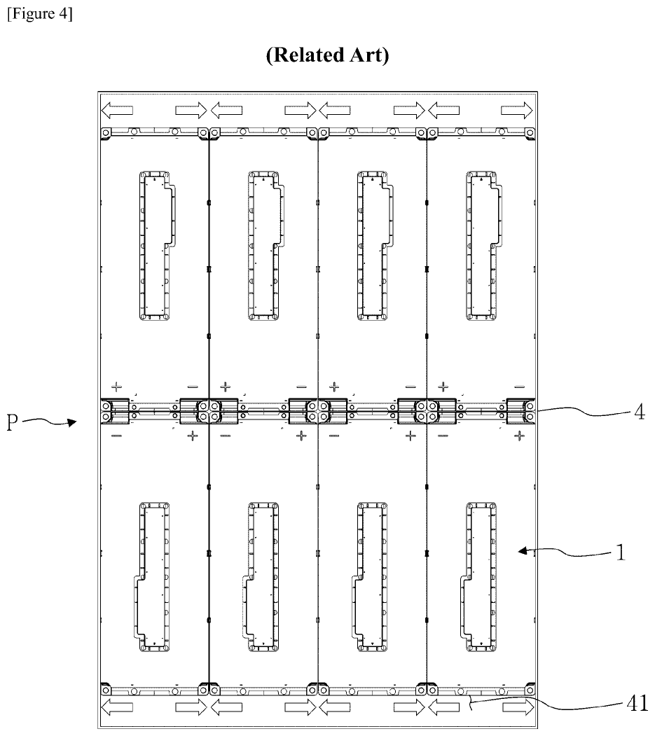

FIG. 2 illustrates a cross-section of the battery module of FIG. 1. Referring to FIG. 2, the end plate 12 may include: the metal portion 122 bonded to the U frame 11; and an injection portion 121 disposed inner than the metal portion 122 and electrically insulating the metal portion 122 from the battery cells 14.

Referring to FIGS. 1 and 2, when the battery cell 14 ignites, the injection portion 121 melts, and high-temperature gas and dust may be discharged through the rear end of the battery module 1 via: the bonding area between the end plate 12 and the U frame 11; and the portion exposing the injection portion. The discharged gas may disperse heat to other battery modules through the rear space of the battery module 1, and the discharged dust may be discharged together with the gas to obstruct the venting path.

The present disclosure provides a structure of a battery pack containing a plurality of battery modules 1 described above wherein thermal propagation is prevented and ventilation is improved, and also provides a structure of a vehicle containing the battery pack.

Hereinafter, an embodiment of the present disclosure will be described with reference to the accompanying drawings.

### First Embodiment

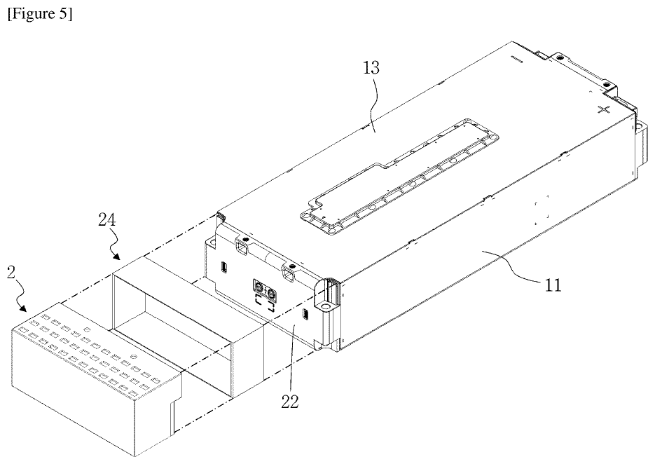

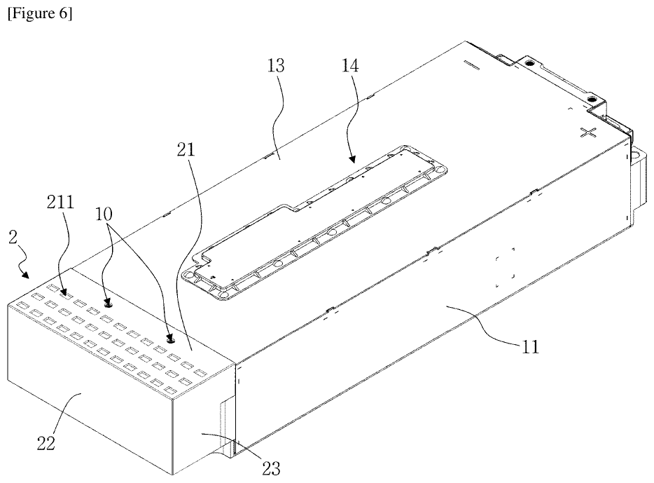

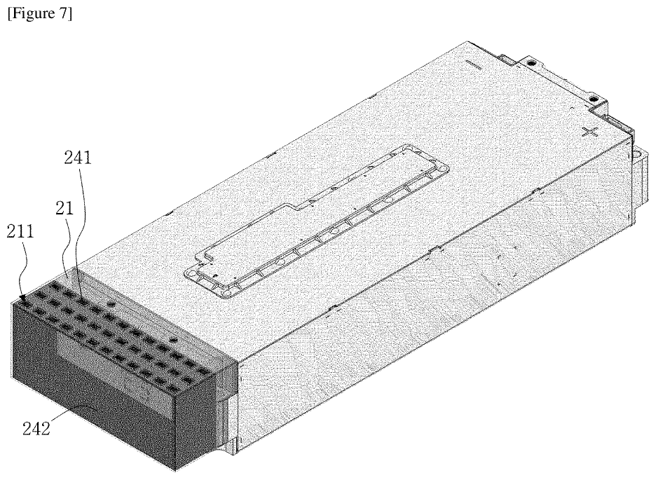

FIGS. 5 to 7 illustrate a battery module and a rear cover coupled to each other according to an embodiment of the present disclosure. Referring to FIGS. 5 to 7, a battery module according to an embodiment of the present disclosure may include a rear cover 2 and a melting frame 24.

The rear cover 2 may include a heat-resistant material. The rear cover 2 according to an embodiment of the present disclosure may include a mica (MICA) material.

The rear cover 2 may have open front end connected to the rear end of the battery module. In addition, it is preferable that the rear cover 2 has an open lower end similar to the front end.

The rear cover 2 may further include an upper plate 21 connecting upper end portions of the pair of partition plates 23 to each other and covers an upper end of the rear cover 2, Here, the venting hole 211 facing upward may be provided in the upper plate 21.

Additionally, the rear cover 2 may include a rear plate 22 connecting the rear ends of the pair of partition plates 23 to each other and covering a rear end of the rear cover 2.

The partition plate 23 may isolate the rear end space of the battery module from two widthwise ends thereof. The partition plate 23 may isolate the rear end space of the battery module from the two widthwise ends thereof at least in some sections in the heightwise direction. Here, the partition plate 23 may cover some of the two widthwise ends of the battery module.

The rear cover 2 according to an embodiment of the present disclosure may have a substantially box shape with open front and lower ends. Accordingly, gas discharged from the battery module in the rear direction may flow into the rear cover 2 from the open front end thereof and be discharged to the upper end thereof through the venting hole 211. In addition, accordingly, dust discharged from the battery module in the rear direction may flow the rear cover 2 from the open front end thereof and fall to the lower end thereof through the open lower end thereof. As the discharge path of the gas is bent from the rear direction to the upward direction, the gas may lose some of its energy and be cooled and discharged.

Additionally, according to the first embodiment, the rear end space of the battery module is isolated from other battery modules in the widthwise direction by the partition plate, and thus the gas may be prevented from propagating heat to other battery modules through the rear space.

The melting frame 24 may have a predetermined melting point lower than that of the rear cover 2. The melting frame 24 according to an embodiment of the present disclosure may include a polycarbonate (PC) material.

The melting frame 24 may be in contact with the inner surface or surface of the rear cover 2. Preferably, the melting frame 24 may be coupled to the rear cover 2 so as to be in contact with the inside of the rear cover 2.

The melting frame 24 may include a venting delaying portion 241 covering the venting hole 211. The venting delaying portion 241 may be provided to prevent gas communication through the venting hole 211 in an unmelted state.

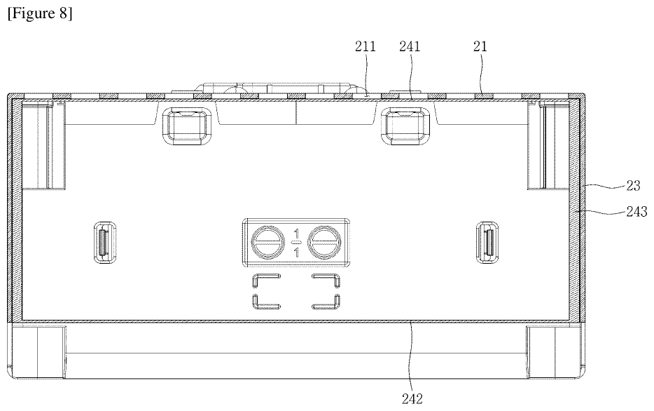

FIG. 8 illustrates a cross-section of a rear cover and a melting frame according to an embodiment of the present disclosure. Referring to FIG. 8, the venting delaying portion 241 may be thinner than other portions of the melting frame 24. Accordingly, when the venting delaying portion 241 is heated above the melting point, the venting delaying portion 241 may be completely melted faster than other portions of the melting frame 24.

According to an embodiment of the present disclosure, the melting frame 24 may have a substantially box shape with open front and rear ends, and the venting delaying portion 241 is provided at the upper plate 21 of the melting frame provided at the lower end of the upper plate 21 of the rear cover 2 such that the venting hole 211 is covered from the bottom. Here, an upper plate 241 and a lower plate 242 of the melting frame 24 may be thinner than two side plates 243 thereof.

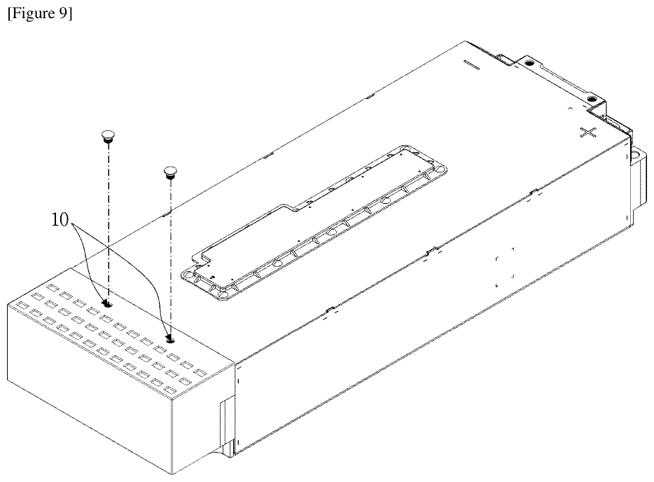

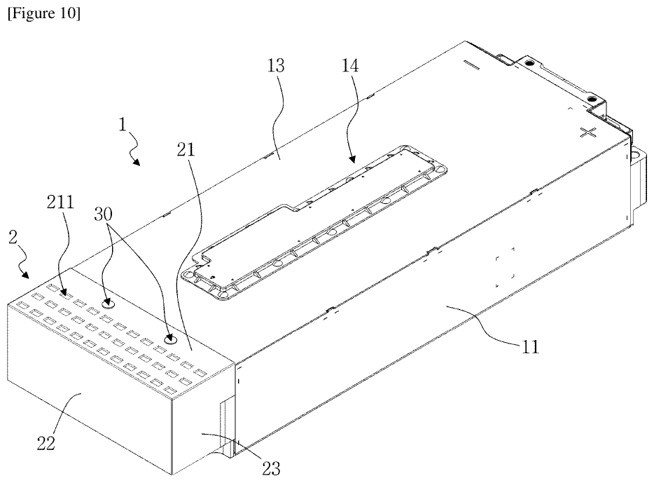

FIGS. 9 and 10 illustrate a battery module and a rear cover fastened to each other according to an embodiment of the present disclosure. Referring to FIGS. 9 and 10, the rear cover 2 may be fastened to a first fastening hole 10 provided in the battery module. The first fastening hole 10 may be provided to face upward at the rear end of the battery module. For example, the first fastening hole 10 may be provided at the end plate 12, the top plate 13 or the U frame 11.

Here, a second fastening hole 20 may be provided at the rear cover 2 to face upward direction. Preferably, the second fastening hole 20 may be provided in the upper plate 21 of the rear cover 2 together with the venting hole 211.

The rear cover 2 according to an embodiment of the present disclosure may have an upper plate 21 covering a portion of an upper surface of the battery module, and may be fastened to the battery module by a fastening member 30 that penetrates both the first fastening hole 10 and the second fastening hole 20. The fastening member 30 may be a general fastening member 30 such as a bolt or push rivet, but not limited thereto. For example, the fastening member 30 may be a click fit protrusion provided as part of the rear cover 2 or the battery module.

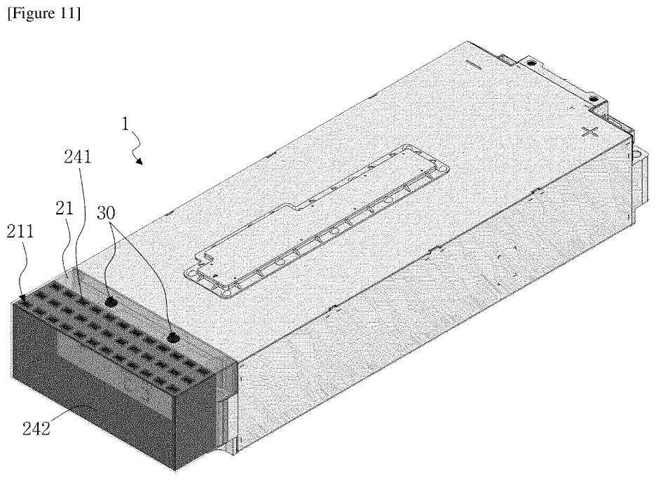

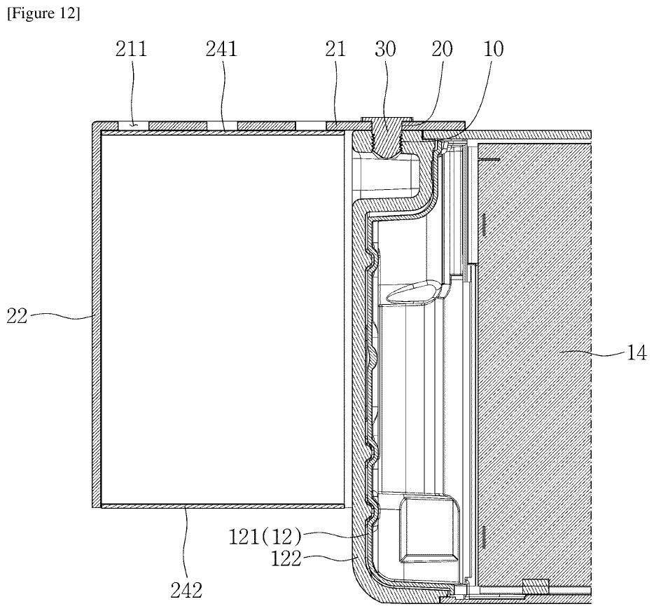

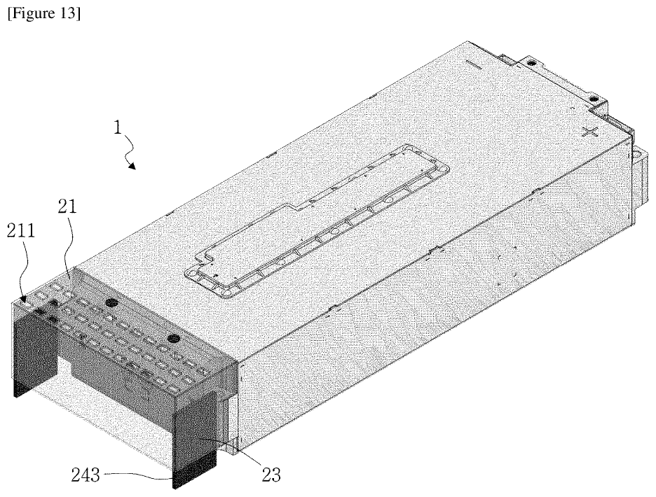

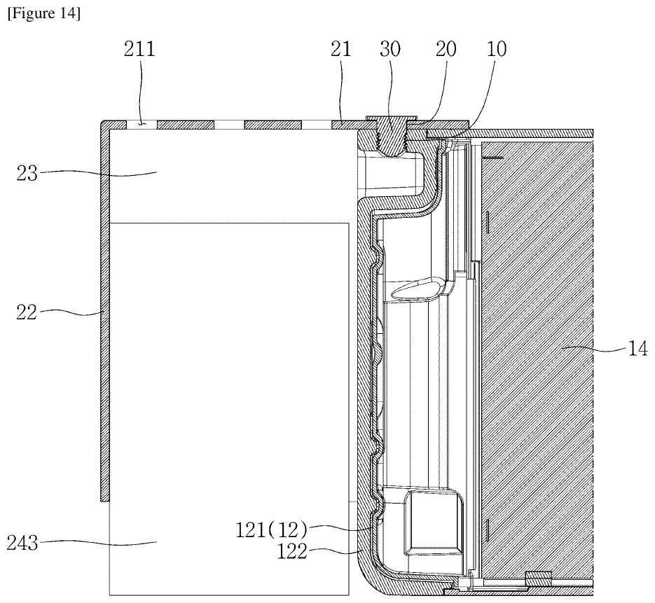

FIGS. 11 and 12 illustrate the structure of the melting frame before melting and a cross-section thereof according to an embodiment of the present disclosure, respectively, and FIGS. 13 and 14 illustrate the structure and a cross-section thereof after melting of the melting frame, respectively, according to an embodiment of the present disclosure. Referring to FIGS. 11 to 14, when the upper plate 241 and the lower plate 242 of the melting frame 24 are heated above the melting point, the upper and lower plates may be completely melted faster than other portions of the melting frame 24. Accordingly, when venting occurs in the battery module, gas discharged from the battery module may be discharged to the upper end of the rear cover 2, and dust discharged from the battery module may fall to the lower end of the rear cover 2. Here, such venting may occur with a delay lasting the melting time of the upper plate 241 and the lower plate 242 of the melting frame 24.

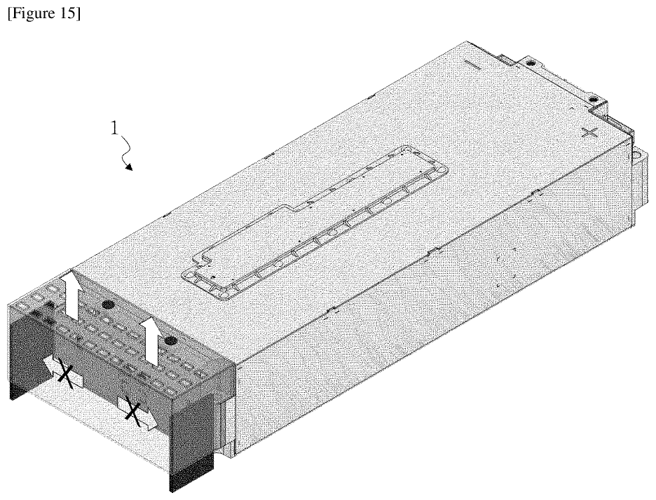

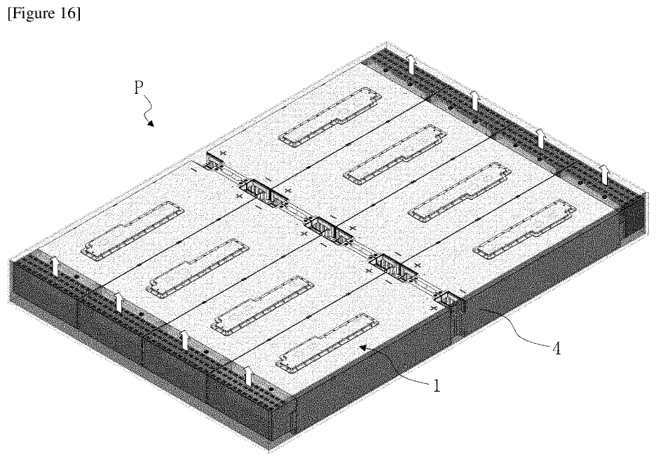

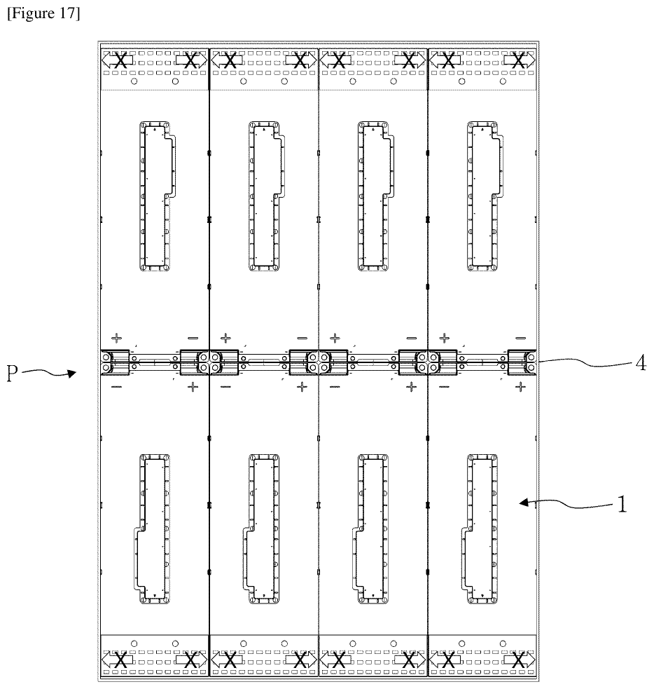

FIG. 15 illustrates the venting action and thermal propagation prevention action of a battery module according to an embodiment of the present disclosure, and FIGS. 16 and 17 illustrate the venting action and thermal propagation prevention action of a battery pack, respectively, according to an embodiment of the present disclosure. Referring to FIGS. 15 to 17, a plurality of battery modules 1 may be arranged in a widthwise direction and accommodated in a pack frame 4 to constitute a battery pack P. A terminal may be provided at the front end of the battery module 1 to electrically connect the battery modules 1, and a rear space 41 may be provided between the rear end of the battery module 1 and the pack frame 4. Gas and dust discharged from the battery module 1 may be vented through the rear space.

After the upper plate 241 and the lower plate 242 of the melting frame are melted, the side plate 243 may fall downward. The side plate 243, along with the partition plate 23 of the rear cover, isolates the rear space 41 from two widthwise ends thereof, thereby preventing lateral thermal propagation cause by gas.

In addition, after flowing into the rear space 41, the gas discharged from the battery module 1 may be delayed by the time period during which the venting delaying portion 241 melts and then vented upward through the venting hole 211. Here, the gas may be cooled and discharged as the venting path thereof is bent.

Additionally, the pack frame 4 according to an embodiment of the present disclosure may be provided with a venting device (not shown) through which gas and dust discharged from the battery module 1 are discharged. Here, the dust is discharged in the rear end of the battery module 1 and falls on the lower end of the rear cover 2 such that there is no risk of obstructing the venting device.

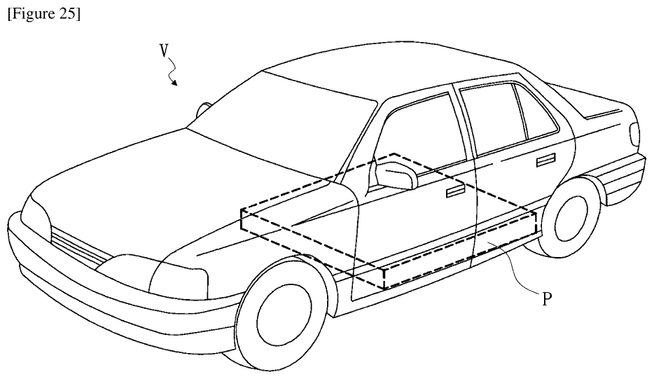

FIG. 25 illustrates the structure of a vehicle containing a battery pack according to the present disclosure. Referring to FIG. 25, the battery pack P may be built into the vehicle V as a power source. The vehicle V may be an electric vehicle or a hybrid vehicle.

### Second Embodiment

Parts not separately described in the second embodiment are the same as those in the first embodiment.

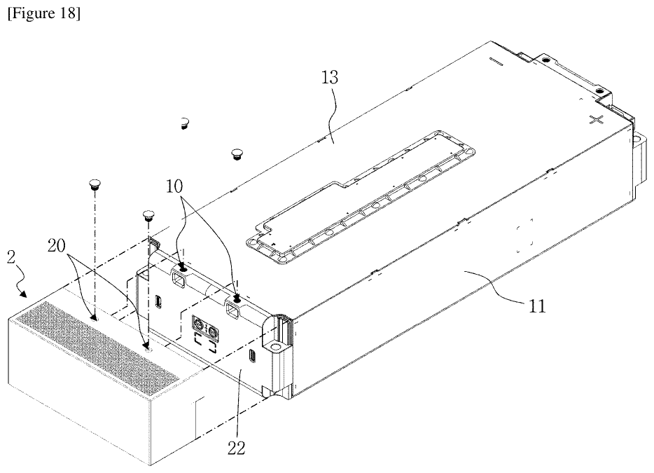

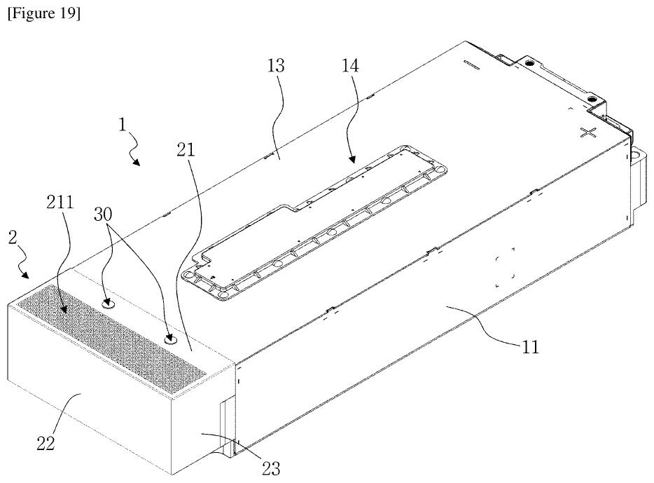

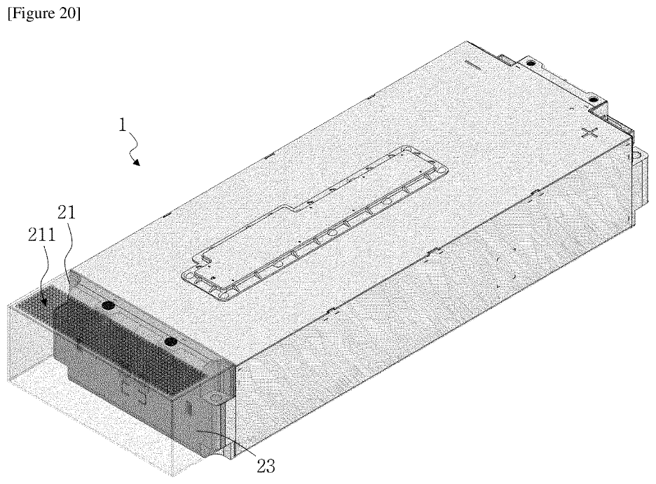

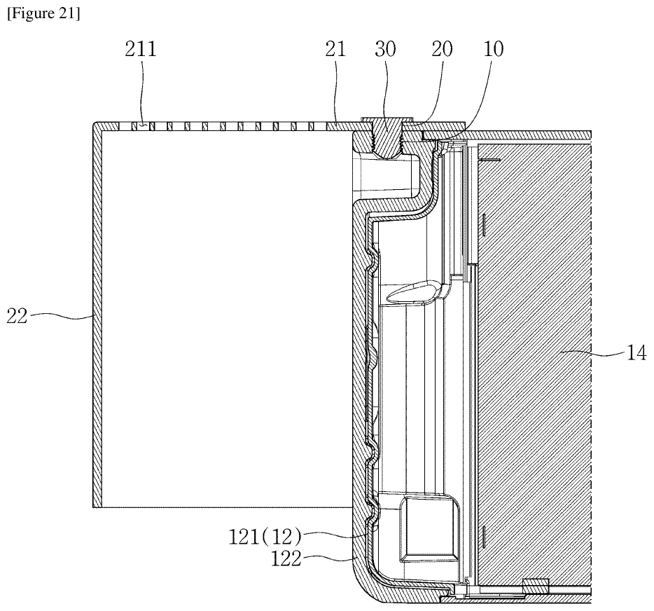

FIGS. 18 and 19 illustrate coupling scheme of a battery module and a rear cover according to another embodiment of the present disclosure, and FIGS. 20 and 21 illustrate the structure of a battery module and a cross-section thereof, respectively, according to another embodiment of the present disclosure. Referring to FIGS. 18 to 21, according to another embodiment of the present disclosure, the venting hole 211 may be covered by a mesh or may have a mesh shape. Alternatively, the venting hole 211 may have a slit shape. However, the shape of the venting hole 211 according to the second embodiment is not limited thereto, and it is sufficient as long as the venting hole 211 has a small opening shape with a width or area smaller than a predetermined value.

According to another embodiment of the present disclosure, the melting frame 24 may not be provided separately.

According to another embodiment of the present disclosure, by forming the venting hole 211 small, the flow rate of gas discharged through the venting hole 211 may be reduced, and venting may be delayed even when the melting frame 24 is not separately provided. In addition, according to the second embodiment, the gas discharged in the rear end of the battery module 1 to be initially cooled by bending the venting path is throttled while passing through the venting hole 211 having a small cross-sectional area and then cooled again.

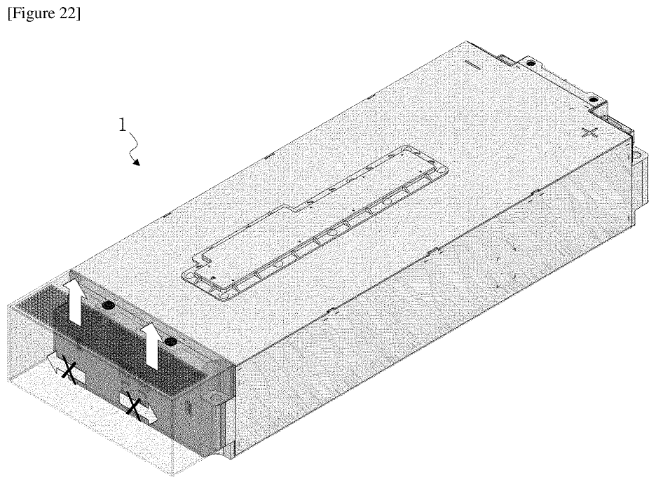

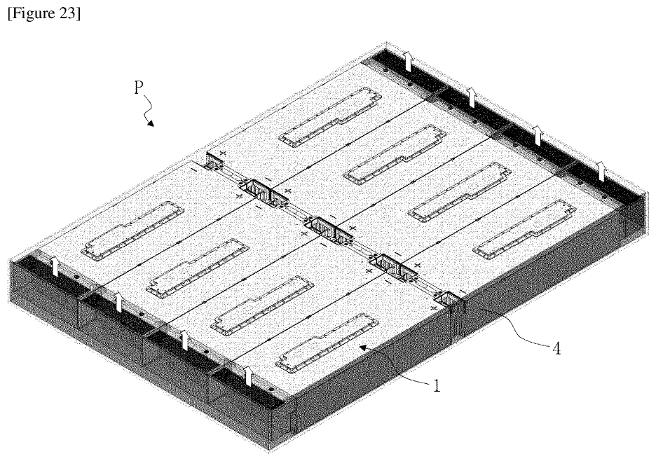

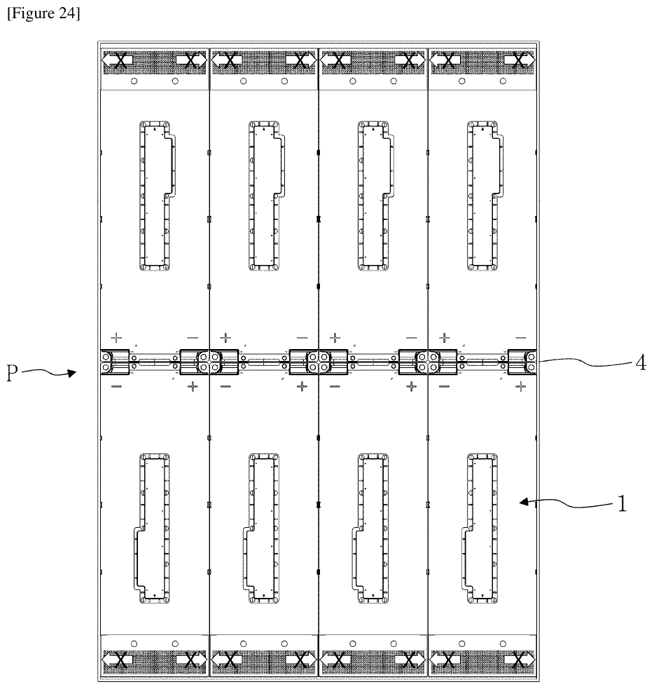

FIG. 22 illustrates the venting action and thermal propagation prevention action of a battery module according to another embodiment of the present disclosure, and FIGS. 23 and 24 illustrate the venting action and thermal propagation prevention action of a battery pack, respectively, according to another embodiment of the present disclosure. Referring to FIGS. 22 to 24, in the battery pack P according to another embodiment of the present disclosure, thermal propagation between modules through the rear space 41 is prevented by the partition plate 23 of the rear cover 2. In addition, according to the second embodiment, the gas discharged from the battery module 1 in the rear direction may be first cooled by passing through a curved path, and then throttled and cooled by passing again through the mesh-shaped venting hole 211. In addition, according to the second embodiment, the dust discharged from the battery module 1 falls onto the open lower end of the rear cover 2, and then is accumulated so as to be discharged upward, thereby preventing the obstruction of the venting path including the venting device.

It should be understood that the described embodiments are illustrative in all respects and not restrictive, and the scope of the present disclosure will be indicated by the following claims rather than the described detailed description. And the meaning and scope of the claims to be described later, as well as all changes and modifications derived from the equivalent concept should be interpreted as being included in the scope of the present disclosure.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and idea of the present disclosure. Further, although the operating effects according to the configuration of the present disclosure are not explicitly described while describing an embodiment of the present disclosure, it should be appreciated that predictable effects are also to be recognized by the configuration.

What is claimed is:

1. A battery pack comprising a plurality of battery modules in a widthwise direction thereof, each of the plurality of battery modules comprising:
an end plate comprising at least a portion of a rear surface of the battery module; and a rear cover at a rear end of the end plate, the rear cover having an open front end and made of a heat-resistant material,
wherein the rear cover comprises: a pair of partition plates extending in a rear direction from two widthwise ends of a rear end of the battery module; and a venting hole facing an upward direction.

2. The battery pack of claim 1, wherein the rear cover is fastened to a first fastening hole in the battery module.

3. The battery pack of claim 2, wherein the rear cover further comprises an upper plate connecting upper end portions of the pair of partition plates to each other and covering an upper end of the rear cover,
wherein the upper plate includes the venting hole and a second fastening hole facing upward,
the first fastening hole faces upward at the rear end of the battery module, and
the rear cover covers a portion of an upper surface of the battery module, and is fastened to the battery module by a fastening member penetrating both the first fastening hole and the second fastening hole.

4. The battery pack of claim 3, wherein the partition plate covers a portion of two widthwise ends of the battery module.

5. The battery pack of claim 1, wherein the rear cover comprises a rear plate connecting the rear ends of the pair of partition plates to each other and covering a rear end of the rear cover.

6. The battery pack of claim 1, wherein the rear cover has an open lower end.

7. The battery pack of claim 1, wherein the rear cover comprises a melting frame, and the melting frame comprises a venting delaying portion covering the venting hole.

8. The battery pack of claim 7, wherein the venting delaying portion is thinner than other portions of the melting frame.

9. The battery pack of claim 7, wherein the melting frame is substantially box shaped with open front and rear ends, and
an upper plate and a lower plate of the melting frame are thinner than two side plates.

10. The battery pack of claim 7, wherein the melting frame has a predetermined melting point lower than the melting point of the rear cover.

11. The battery pack of claim 1, wherein the rear cover comprises mica material.

12. The battery pack of claim 7, wherein the melting frame comprises polycarbonate (PC) material.

13. The battery pack of claim 1, wherein the venting hole is covered with mesh.

14. The battery pack of claim 1, wherein the venting hole has a mesh shape.

15. The battery pack of claim 1, wherein the venting hole has a slit shape.

16. A vehicle comprising a battery pack of claim 1.
